(19) United States
(12) Patent Application Publication
(10) Pub. No.: US 2006/0284462 A1
(43) Pub. Date: Dec. 21, 2006

(54) Medical chair

(76) Inventor: Yu Wen Cheng, Taichung City (TW)

Correspondence Address: PRO-TECHTOR INTERNATIONAL, 20775 Norada Court, Saratoga, CA, 95070-3018, US

(21) Appl. No.: 11/154,393

(22) Filed: Jun. 15, 2005

(51) Int. Cl. A61G 15/00

(52) U.S. Cl. 297/326

(57) ABSTRACT

A medical chair comprises a frame, a seat assembly, at a front edge thereof hingedly connected with the frame, and a lifting device, further comprising a first rod, a second rod, a curved section, inserted between the first rod and the second rod, and a holding element, through which the curved section is led, freely gliding therein, so that a user, upon pressing the second rod forward and downward, causes a far end of the first rod to rise, lifting the seat assembly at the rear side thereof, facilitating getting up of the user to a standing position.

### BACKGROUND OF THE INVENTION

1. Field of the Invention

The present invention relates to a medical chair, particularly to a medical chair having a supporting arm allowing a disabled person to sit down and stand up without assistance.

2. Description of Related Art

People injured at the legs or disabled at the lower body usually master daily life with the help of wheelchairs, canes or walkers. Activities like eating, going to sleep, showering or going to the toilet all need support by a supporting device.

For patients who are injured or disabled at the lower body, being unable to stand up on their own, medical chairs have been developed to provide support for the bottom and the back to perform daily activities like sitting up, eating, showering or going to the toilet without the assistance of other persons.

There are, however, patients or elder people who are only slightly disabled at the lower body. These people are able to walk by themselves with the aid of a cane or a walker, but are too weak to get up from a sitting to a standing position without assistance, so are severely hindered to perform daily duties. Moreover, attempting to get up without assistance often results in loss of balance and falling down.

With this problem in mind, U.S. Pat. No. 4,929,022 “Chair Having Lift Apparatus” discloses a medical chair with a seat that on demand is driven by a rod to incline downward. The seat has a front part which is hingedly connected with a frame. The rod is lifted by a hand or stepped on by a foot for driving the seat to be inclined, allowing a user to slid forward on the seat and come to a standing position.

Although the medical chair just described allows a patient to get up, the structure thereof is complicated, has to be mounted beneath a frame of the medical chair and takes up much volume, so that installation of further devices is not always possible, limiting the range of applications.

### SUMMARY OF THE INVENTION

The main object of the present invention is to provide a medical chair which allows a patient to get up to a standing position without assistance.

The medical chair of the present invention has a seat assembly, at a front edge thereof hingedly connected with a frame, and a lifting device, working as a lever which is on one end connected with the seat assembly at a rear side thereof. A user, upon pressing an opposite end forward and downward, operates the lever, lifting the seat assembly at the rear side thereof, facilitating getting up of the user to a standing position.

The present invention can be more fully understood by reference to the following description and accompanying drawings.

### DETAILED DESCRIPTION OF THE PREFERRED EMBODIMENTS

As shown in FIG. 1, the medical chair of the present invention mainly comprises: a base frame 10; a seat assembly 20; and a lifting device 30. The base frame 10 supports the seat assembly 20 and comprises further: two front legs 11 and two rear legs 12, supporting the medical chair when put on the ground; a front horizontal bar 13, connecting the front legs 11; a rear horizontal bar 14, connecting the rear legs 12; and lest and right connecting bars 15, 16, each connecting one of the front legs 11 with one of the rear legs 12.

The seat assembly 20 is movably placed on the base frame 10 and comprises further: a seat frame 21; a seat 22, providing support of a bottom of a user; two armrests 23, preventing falling of the user sideways off the medical chair; and a backrest 24, supporting a back of the user.

Furthermore, the seat assembly 20 has at least two hinges 25, thereby being hingedly connected with the front horizontal bar 13. Thus the seat assembly 20 allows to be turned around a horizontal axis at a front edge thereof.

The lifting device 30 is mounted on the right and left connecting bars 15, 16 of the base frame 10 and serves to lift the seat assembly 20 at a rear side thereof, so that the seat assembly is inclined downward towards the front edge thereof, facilitating getting up of the user by easily lifting the bottom and sliding forward.

Referring to FIGS. 1-3, the lifting device 30 is mounted on the left and right sides, on each side further comprising: a first rod 31; a second rod 33; a curved section 34; and a handle 37. The first rod 31 has a far end which is connected via a multidirectional connector 32 to the rear side of the seat assembly 20. The second rod 33 is oriented perpendicular to the first rod 31, having a far end that extends to the arm rests 23, conveniently in the reach of the user. The curved section 34 is inserted between the first and second rods 31, 33 and is held by a holding element 35 on the right and left connecting bars 15, 16. The handle 37 is attached to the far end of the second rod 33 to be gripped conveniently by a hand of the user for operating the lifting device 30. In a rest state, the handle 37 is pushed over or inside the second rod 33 for better looks and convenience.

Referring again to FIG. 3, the holding element 35 is fixed on the right and left connecting bars 15, 16, having a central hole 36 into which the curved section 34 is inserted. Preferably, the holding element 35 has a surface made of material of low friction, and the central hole 36 is made with smooth walls, allowing the curved section 34 to glide with little friction within the holding element 35.

As shown in FIGS. 3-4, since the central hole 36 has a diameter that is larger than the diameter of curved section 34, the curved section 34 glides easily within the central hole 36. Due to a position within the lifting device 30 and restrictions by the holding element 35, the curved section 34 is a leverage point for lifting the seat assembly 20 by operating the lifting device 30.

Referring again to FIG. 4, the lifting device 30 takes advantage of combined lengths of the second rod 33 and the handle 37, which are greater than the length of the first rod 31, magnifying any manual force applied on the handle for lifting the body of the user.

For getting up, the user operates with both hands the lifting device 30, whereby the body of the user is lifted and slides forward due to inclination of the seat assembly 20. Therefore, getting up to a standing position of a person with a disabled lower body but healthy upper body and arms is facilitated and made possible without assistance.

As compared to conventional art, the lifting device 30 has a simple structure and a simple lever mechanism. Furthermore, the lifting device 30 is mounted on the frame 10, not occupying space beneath the frame 10, allowing to install further devices there for extended applications.

Other applications of the present invention are possible, e.g., usage in humid environments, by employing hydrophobic material or stainless steel, as in bathrooms, or usage as toilet seat, with a toilet bowl 40 placed beneath the frame 10 and an opening 26 cut into the seat 21, allowing for convenient use of a toilet.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a perspective view of the medical chair of the present invention.

FIG. 2 is a side view of the medical chair of the present invention.

FIG. 3 is an enlarged perspective view of area A of FIG. 1.

FIG. 4 is a schematic illustration of the use of the present invention.

FIG. 5 is a perspective view of the medical chair of the present invention in the second embodiment.

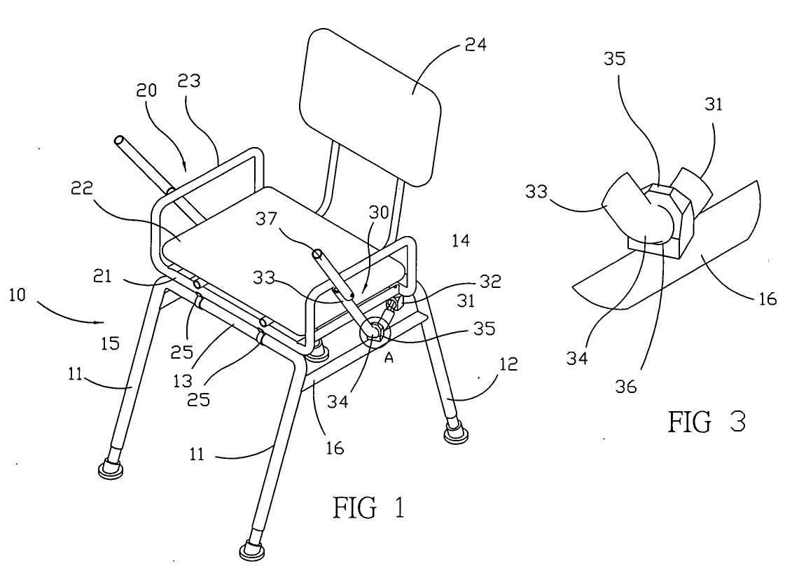

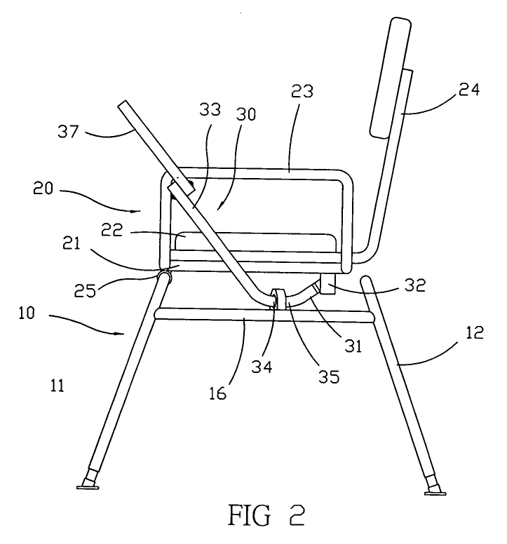

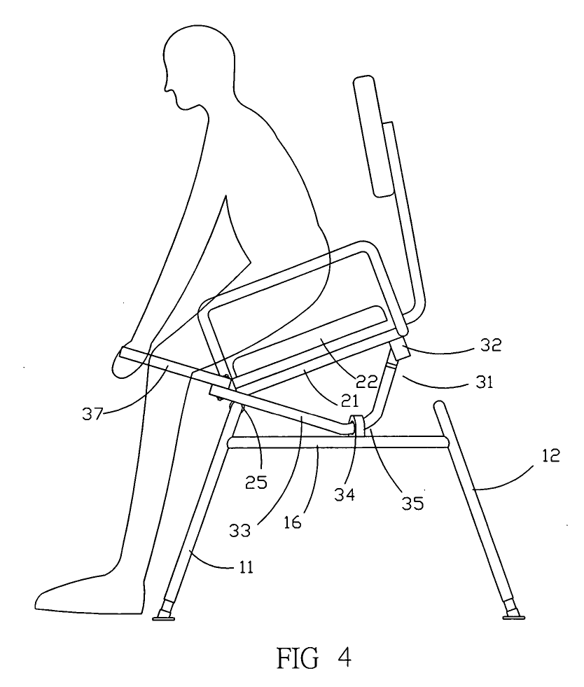

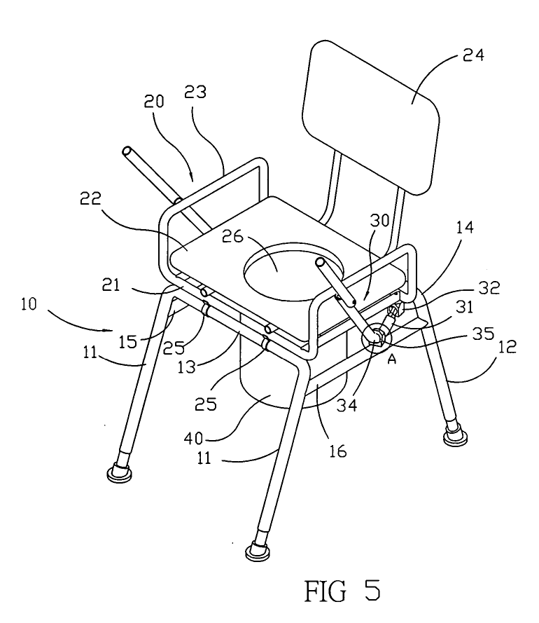

1. A medical chair comprising:
a frame, having two front legs, two rear legs, front and rear horizontal bars, and left and right connecting bars, defining left and right sides;
a seat assembly, at a front edge thereof hingedly connected with said front horizontal bar; and
a lifting device, mounted on said left and right sides, on each side further comprising
a first rod, having a far end that is under variable directions connected with said seat assembly at a rear side thereof,
a second rod, having a far end for being pressed forward and downward by a user,
a curved section, inserted between said first rod and said second rod, and
a holding element, fixed to one of said left and right connecting bars, having a central hole through which said curved section is led, freely gliding therein;
wherein said user, upon pressing said far end of said second rod forward and downward, causes said far end of said first rod to rise, lifting said seat assembly at said rear side thereof, facilitating getting up of said user to a standing position.

2. The medical chair according to claim 1, wherein said first rod at said far end thereof is by a multidirectional connector connected with said seat assembly at said rear side thereof.

3. The medical chair according to claim 1, wherein said seat assembly at said front edge thereof is connected with said front horizontal bar by a plurality of hinges.

4. The medical chair according to claim 1, wherein said first rod has a length and said second rod has a length which is greater than said length of said first rod.

5. The medical chair according to claim 1, wherein said second rod at said far end thereof has a handle which allows to be extended and pushed back.
